(19) United States
(12) Patent Application Publication
(10) Pub. No.: US 2004/0106406 A1
(43) Pub. Date: Jun. 3, 2004

(54) Server using wireless application protocol

(76) Inventors: Martin De Loye, Sevres (FR); Jean-Francois DePrun, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/343,978

(22) PCT Filed: Aug. 13, 2001
(86) PCT No.: PCT/FR01/02608

(30) Foreign Application Priority Data
Aug. 24, 2000 (FR) 00/10896

(51) Int. Cl. H04Q 7/20

(52) U.S. Cl. 455/436; 455/445

(57) ABSTRACT

The invention provides a WAP server (20) connected to a radiotelephone network (18) and to at least one switch (22; 24) of said radiotelephone network. The server includes means for receiving calls or requests from mobile telephones (10_{A}; 10_{B}). On the basis of these calls or requests, a switch of the radiotelephone network (22; 24) modifies the routing of calls coming from the mobile telephone (10_{A}; 10_{B}) or going to the mobile telephone (10_{A}; 10_{B}). By way of example, the switch may enable a call to a fixed telephone to be transferred to a mobile radiotelephone.

The invention relates to a server using the wireless application protocol, commonly referred to by the initials “WAP”.

The wireless application protocol was developed to enable mobile radiotelephones to have access to an Internet type network, i.e. a network comprising a variety of servers providing free access to data.

To limit the time needed for transmitting information to mobile telephones, which operate at a transmission rate of 9.6 kilobits per second (kbit/s) that is well below the rate needed to use the Internet (56 kbit/s), WAP includes a programming language (WAP markup language or WML) that is more restricted than the programming language used on the Internet, i.e. hypertext markup language (HTML).

Thus, the set of all servers integrating the WAP protocol constitutes a network that is accessible from a radiotelephone that also integrates the WAP protocol, via an entry portal at the interface between the telephone network and each server using the WAP protocol. The term “WAP” server is used below to designate a server which includes an entry portal.

The present invention results from the observation that in addition to giving access to multiple sources of information, WAP also makes it possible to give new functions to a mobile radiotelephone. In particular, it makes it possible to cause programs stored on a server to be executed.

The invention provides a server connected to a radiotelephone network via the wireless application protocol, which server is characterized in that it includes means for receiving calls or requests from mobile telephones and for responding to said calls or requests to control a switch of the radiotelephone network so as to modify the routing of calls coming from the mobile telephone or going to the mobile telephone.

The server may control the switch either directly or by means of an authorization given by the server to the mobile telephone so as to enable it to act on the switch, which authorization may be given in the form of a code, for example. Under such circumstances, the mobile radiotelephone uses its wireless telephone application interface (WTAI) for transmitting these codes.

In an embodiment, the switch may enable calls received by a fixed telephone to be rerouted to the mobile radiotelephone.

In another application, the WAP server may be used to cause a party called on the public network to be connected over a private network if the calling and called parties are both on the private network. This may serve to reduce the cost of calls.

In another embodiment, the server is of private type and enables the mobile telephone to connect to any server on the Internet while a call made directly without passing via the private server would allow the mobile telephone only limited access to the WAP network because of a restriction imposed by a public operator on its server.

The invention also provides a mobile telephone capable of sending messages or requests to the server.

In short, the invention provides a WAP server connected to a radiotelephone network and to at least one switch in said telephone network. The server has means for receiving calls or requests from mobile telephones in order to respond to these calls or requests by controlling a switch of the radiotelephone network so as to change the routing of calls coming from the mobile telephone or going to the mobile telephone.

In an embodiment, the server means for supplying the mobile telephone with a signal such as a code that is then forwarded by the telephone to the switch in order to control routing.

The server may include means to cause the switch to allow a call to be transferred from a fixed telephone to a mobile radiotelephone.

In an embodiment, the server has means for controlling the switch so that if the calling and called parties are both on the same private network, then the call takes place solely via the private network without passing via an external network.

In an embodiment in which the server is in a private network, the server includes means to enable a mobile radiotelephone of said private network to access a plurality of servers outside the private network.

Other characteristics and advantages of the invention appear from the following description of various embodiments given with reference to the accompanying drawings, in which:

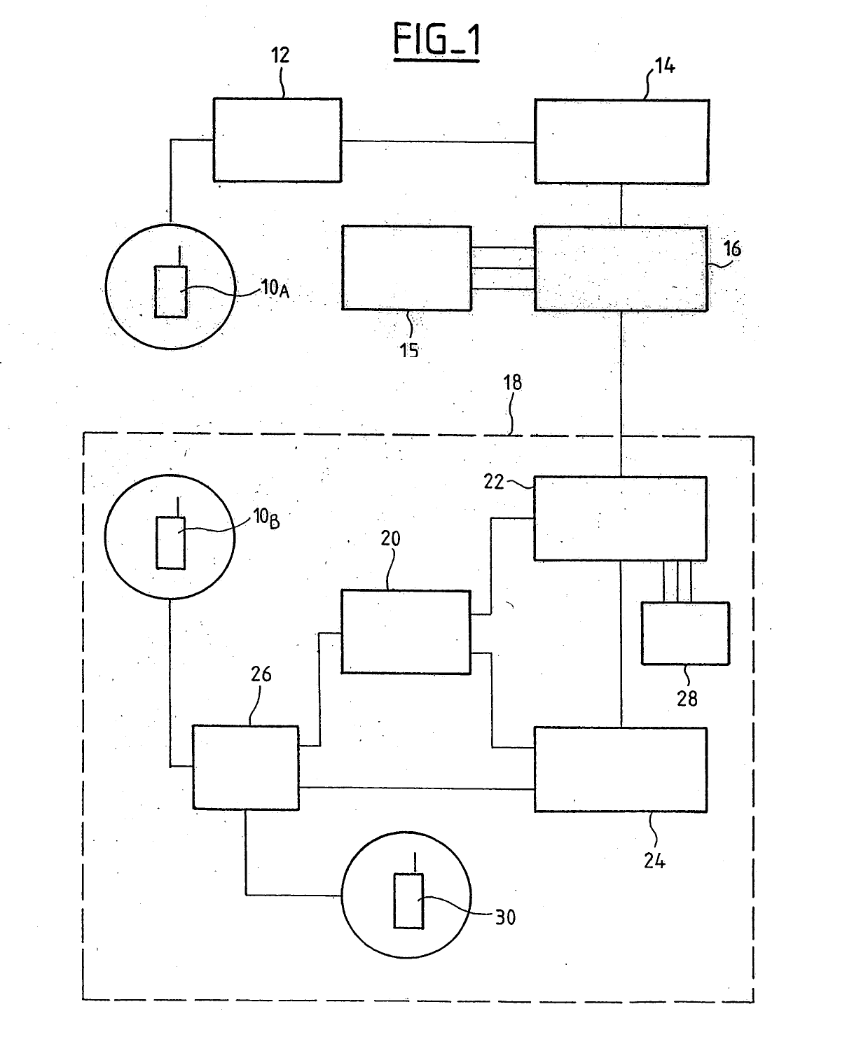

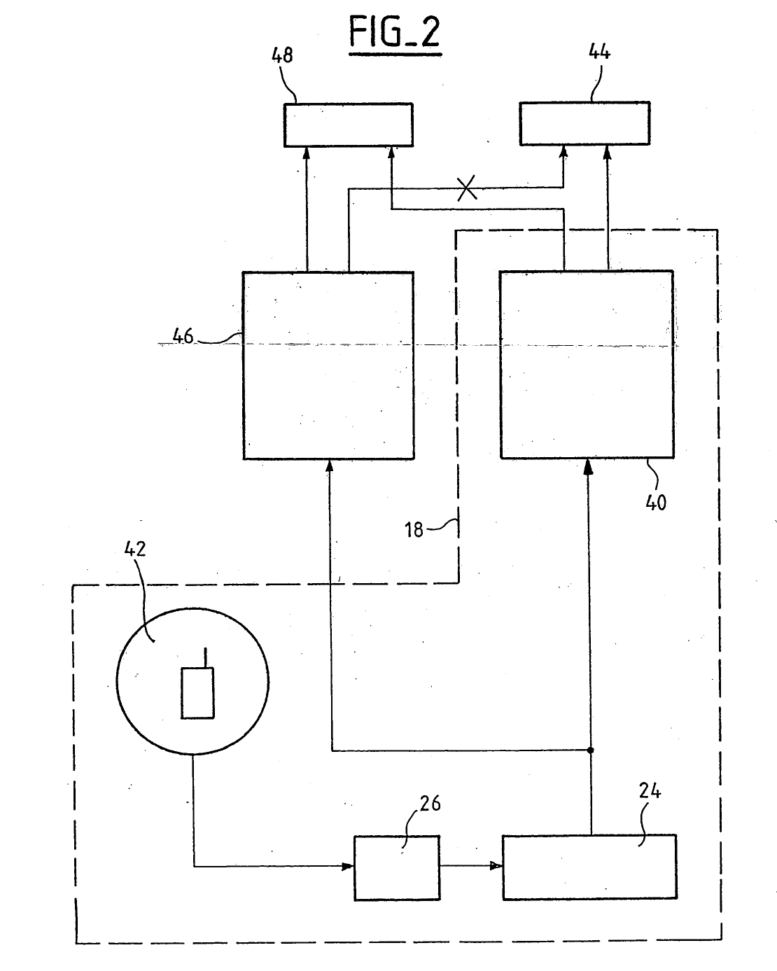

FIGS. 1 and 2 are diagrams showing networks, each including a server in accordance with the invention.

In FIG. 1, two mobile radiotelephones 10_{A} and 10_{B} are provided which are in two different situations.

In the first case, A), calls from the radiotelephone 10_{A} are transmitted over a public network, i.e. a network that is accessible to any person paying a subscription. In addition, calls made by the mobile radiotelephone 10_{A} are billed by the public operator.

In the second case, B), calls from the radiotelephone 10_{B} are transmitted over a private network, for example a business network.

When radiotelephone 10_{A} communicates with mobile radiotelephone 10_{B}, calls from the mobile radiotelephone 10_{A} to the mobile radiotelephone 10_{B} are received by public base cell 12, e.g. in the global system for mobile communications (GSM), they are transmitted to a switch 14 of the public mobile network, to a switch 16 of the public wired network, and finally they are forwarded to the private network 18.

Within the private network 18, these calls are directed to a switch 22 of the private wired network, and then to a switch 24 of the private mobile network and finally to a private base cell 26 which transmits the call to the mobile radiotelephone 10_{B}.

The reverse procedure to that described above is followed when the mobile radiotelephone 10_{B} sends a message to the mobile radiotelephone 10_{A}.

Calls can also be made between a fixed telephone 15 of the public network and a fixed telephone 28 of the private network, in which case the calls pass only via the switch 16 of the public wired network and the switch 22 of the private wired network.

When calls take place between the radiotelephone 10_{A} and a fixed telephone 28 of the private wired network 18, the calls are transmitted via the public base cell 12, the switch 14 of the public mobile network, the switch 16 of the public wired network, and the switch 22 of the private wired network.

Finally, the mobile radiotelephone 10_{B} can also make a call to another mobile radiotelephone 30 or to a fixed telephone 28, without leaving the private network. Under such circumstances, calls can be conveyed over the private network without cost.

In accordance with the invention, an entry portal is provided together with a WAP server 20 shown in FIG. 1. As mentioned above, for reasons of simplicity, a portal and a server are referred to herein as a server.

In the private network 18, the WAP server 20 is accessible from the mobile radiotelephone 10_{B} via the private base cell 26, while from a fixed telephone 28 it is accessible via the switch 22 of the private wired network, providing the fixed telephone 28 uses the WAP protocol.

The WAP server 20 is also accessible from the public network via the switch 22 of the private wired network. Thus, the mobile radiotelephone 10_{A} of the public network and the fixed telephone 15 of said public network can communicate with the server 20.

The WAP server 20 provides access to multiple services stored in its database to mobile or fixed telephone sets both in the private network and in the public network. These services which may be displayed on the screen of the telephone handset, for example, are then selected by the user of the WAP handset.

In this situation, the execution of a program stored in the WAP server 20 or the transmission of a code to the radiotelephone in contact with said server acts on the switch 24 of the private mobile network or on the switch 22 of the private wired network, thus providing the routing modification services requested by the user.

The switch 24 of the private mobile network and the switch 22 of the private wired network operate using protocols that are not compatible with the WAP protocol, so it can clearly be seen why a server of the invention is advantageous: it makes it possible to offer routing services obtained using the switch 24 of the private mobile network and/or the switch 22 of the private wired network, which services would normally (i.e. without the server 20) be inaccessible directly from a WAP radiotelephone.

Examples of services offered by the WAP server are described below:

In a first example, described with reference to FIG. 1, the user of mobile radiotelephone 10_{B} is in the premises of his or her business which has a private network. The mobile radiotelephone 10_{B} is thus within the coverage of the private base cell 26 which forwards this information to the switch 24 of the private mobile network.

When the user of mobile radiotelephone 10_{B} moves about within the business, it is desirable for calls made to that user's fixed telephone 28 to be diverted to the mobile radiotelephone 10_{B}. For this purpose, the user makes the connection to the business WAP server 20 from the mobile radiotelephone 10_{B} which, for example, then displays on a screen the various services that are available, and in particular the “call transfer” function.

When the user selects the “call transfer” function, the mobile radiotelephone 10_{B} receives a code number from the WAP server making it possible to activate the switch 22 of the private wired network to transfer calls to the fixed telephone 28 so that they go to the mobile WAP radiotelephone 10_{B}.

The mobile radiotelephone 10_{B} then calls the switch 22 of the private wired network to activate the transfer function using the code number.

Thereafter, any calls to the fixed telephone 28 are transferred to the mobile radiotelephone 10_{B}.

It should be observed that when a call is transferred to a telephone present in the private network, this service is of no extra cost to any of the users.

That is why, in one embodiment, provision is made for an automatic deactivation mode whenever the mobile radiotelephone 10_{B} towards which calls are being diverted leaves the coverage of the private network. With this deactivation mode, on detecting the absence of the mobile radiotelephone 10_{B} the switch 24 of the private mobile network sends a deactivation signal to the switch 22 of the private wired network. This switch then ceases to transfer calls.

Numerous variants of this example are possible. For example, even if a user is outside the private network, that user can still make a connection to the WAP server 20 in order to obtain call transfer to the mobile radiotelephone. Under such circumstances, disconnection of this service is done manually.

In this example, the mobile radiotelephone obtains from the WAP server 20 the information needed to act on the switch 22 of the private wired network. This information is received by the mobile radiotelephone 10_{B} by means of its wireless telephone application interface (WTAI).

In another example, a call charge reducing service is offered to the users of radiotelephones that have access to directories of telephone numbers located in the server.

For this purpose, when a user of radiotelephone 10_{B} makes a call, a connection is made to the WAP server 20 which has a directory of people working in the business to which the WAP server is attached. Amongst the names on offer, the user of the radiotelephone selects the person to be called.

The mobile radiotelephone then calls the number associated with the called person by means of its WTAI.

For example, this number corresponding to fixed telephone 28 or to a mobile telephone 30 might be 33 123 45678, with the last four digits 5678 corresponding to the extension number of the called party.

Under such circumstances, while the radiotelephone 10_{B} is within the coverage of the private business network, the switch 24 of the private mobile network changes the called number into an internal extension number, i.e. in this example it changes 33 123 45678 into 5678.

This enables the user of the radiotelephone to access the directory in the server, thereby making it possible to achieve cost reductions, depending on whether or not the called party is present in the private network.

FIG. 2 shows an example of a service available from a WAP server 40 that makes it possible to obviate the restrictions on access to WAP networks that might be imposed by particular mobile radiotelephone operators. For example, if the proprietor of the mobile telephone is a subscriber only to one operator's network then, as a general rule, access is not available to the WAP servers of other operators.

In the example of FIG. 2, the user of a radiotelephone 42 cannot access a page 44 since that is not allowed by the operator of the network to which the user subscribes.

In accordance with the invention, the user of a WAP radiotelephone can access this page by means of the business server 40.

To do this, the user, while within the private network, uses the WAP radiotelephone to make a connection to an address via the business server 40 even though this is done by dialing the public call number of the server 46. To do this, a symbol such as “#” is added in front of the number of the server 46, for example.

In this example, a user seeking to make a connection to an address 44 which is not accessible via the WAP server 46 of the public operator, avoids using the WAP server 46 of the public operator by keying “#” followed by the number of the server 46. The call is then directed to the business server 40. Otherwise the call is directed to the server 46 which then imposes the address 48.

By being connected to the private WAP server 40, the user of the WAP mobile telephone 42 can make a connection to the desired address.

Furthermore, in FIG. 2, the private base cell 26 and the switch 24 of the private mobile network, described above with reference to FIG. 1, are also shown. Their roles in the private network 18 are similar to those described above with referred to FIG. 1.

1/ A WAP server (20; 40) connected to a radiotelephone network (18) and to at least one switch (22; 24) of said telephone network, the server being characterized in that it includes means for receiving calls or requests from mobile telephones (10_{A}; 10_{B}) and for responding to said calls or requests to control a switch of the radiotelephone network (22; 24) so as to modify the routing of calls coming from the mobile telephone (10_{A}; 10_{B}) or going to said mobile telephone (10_{A}; 10_{B}).

2/ A WAP server (20) according to claim 1, characterized in that in order to control the switch it has means for supplying the mobile telephone (10_{A}; 10_{B}) with a signal such as a code that is then forwarded by the telephone to the switch (22; 24) in order to control routing.

3/ A WAP server (20) according to claim 1, characterized in that it has means to cause the switch (22; 24) to allow a call to be transferred from a fixed telephone (28) to a mobile radiotelephone (10_{A}; 10_{B}).

4/ A WAP server (20) according to claim 1, characterized in that it has means for controlling the switch (22; 24) so that if the calling and called parties (10_{B}; 28, 30) are both on the same private network (18), then the call takes place solely via the private network (18) without passing via an external network.

5/ A WAP server (40) according to any preceding claim, characterized in that the server is in a private network (18) and has means to enable a mobile radiotelephone (10_{B}) of said private network to access a plurality of servers external to the private network.

6/ A mobile radiotelephone (10_{A}; 10_{B}) connected to a private network (18) having a WAP server (20; 40) and to at least one switch (22; 24) of said telephone network, the mobile radiotelephone being characterized in that it has means for transmitting requests or calls to the WAP server (20; 40) which responds to said calls or requests to control a switch (22; 24) of the radiotelephone network so as to modify the routing of calls coming from the mobile telephone (10_{A}; 10_{B}) or going to said mobile telephone (10_{A}; 10_{B}).
